(19) United States
(12) Patent Application Publication
(10) Pub. No.: US 2012/0050912 A1
(43) Pub. Date: Mar. 1, 2012

(54) Hydrodynamic bearing assembly, motor provided with the hydrodynamic bearing assembly and recording disk driving device equipped with the motor

(75) Inventor: Ta Kyoung Lee, Hwaseong (KR)

(73) Assignee: SAMSUNG ELECTRO-MECHANICS CO., LTD., Suwon (KR)

(21) Appl. No.: 13/067,468

(22) Filed: Jun. 2, 2011

(30) Foreign Application Priority Data
Aug. 25, 2010 (KR) 10-2010-0082670

(51) Int. Cl. G11B 17/02; H02K 7/08; F16C 32/06

(52) U.S. Cl. 360/99.08; 384/100; 310/90; G9B/17.002

(57) ABSTRACT

There are provided a hydrodynamic bearing assembly capable of implementing a flat-type oil cover, while reducing a thickness of the oil cover, by strengthening the rigidity of the oil cover, a motor having the hydrodynamic bearing assembly, and a recording disk driving device equipped with the motor. The hydrodynamic bearing assembly includes: a sleeve having a shaft hollow provided at one side thereof, the shat hollow being inserted with a shaft; and an oil cover fixed to the sleeve in another direction of the shaft hollow and preventing a leakage of oil remaining in the shaft hollow, wherein a groove for securing rigidity is formed on at least one surface of the oil cover.

### CROSS-REFERENCE TO RELATED APPLICATIONS

This application claims the priority of Korean Patent Application No. 10-2010-0082670 filed on Aug. 25, 2010, in the Korean Intellectual Property Office, the disclosure of which is incorporated herein by reference.

### BACKGROUND OF THE INVENTION

1. Field of the Invention

The present invention relates to a hydrodynamic bearing assembly, a motor having the hydrodynamic bearing assembly, and a recording disk driving device equipped with the motor, and more particularly, to a hydrodynamic bearing assembly capable of implementing a flat-type oil cover, while reducing a thickness of the oil cover, by strengthening the rigidity of the oil cover provided so as to prevent oil leakage, a motor having the hydrodynamic bearing assembly, and a recording disk driving device equipped with the motor.

2. Description of the Related Art

A small-sized spindle motor used in a recording disk driving device is equipment using a hydrodynamic bearing assembly, in which oil is interposed between a shaft and a sleeve of the hydrodynamic bearing assembly and the shaft is supported by hydrodynamic pressure generated from the oil.

With the recent improvement of performance in recording disk driving devices, there has been an increased demand for low current consumption, low non-repeatable run out (NRRO), impact resistance, vibration resistance, and the like.

In particular, as a spindle motor for a hard disk drive (HDD) has been applied to various portable products, such as net books, cellular phones, PMPs, game machines, or the like, research into the compactness thereof has been actively conducted.

Generally, a hydrodynamic bearing assembly of a motor for a hard disk drive includes an oil cover formed at an end of a sleeve at an opposite side to which a shaft is inserted, the oil cover for preventing a leakage of oil interposed between the shaft and the sleeve.

In order to secure sufficient characteristics, while accomplishing compactness, securing a maximum length of a bearing is required and thus reducing a thickness of the oil cover is required.

Therefore, there is a demand for a technology capable of securing the rigidity of the oil cover, while sufficiently reducing the thickness of the oil cover.

### SUMMARY OF THE INVENTION

An aspect of the present invention provides a hydrodynamic bearing assembly capable of implementing a flat-type oil cover, while reducing a thickness of the oil cover, by strengthening the rigidity of the oil cover, a motor having the hydrodynamic bearing assembly, and a recording disk driving device equipped with the motor.

According to an aspect of the present invention, there is provided a hydrodynamic bearing assembly, including: a sleeve having a shaft hollow provided at one side thereof, the shat hollow being inserted with a shaft; and an oil cover fixed to the sleeve in another direction of the shaft hollow and preventing a leakage of oil remaining in the shaft hollow, wherein a groove for securing rigidity is formed on at least one surface of the oil cover.

The groove for securing rigidity may be radially formed on one surface of the oil cover. The groove for securing rigidity may have a width widening in a direction towards an outer peripheral portion of the oil cover.

The groove for securing rigidity may have a shape of a plurality of concentric circles formed on one surface of the oil cover. The groove for securing rigidity may have a shape in which the plurality of concentric circles are at least partially connected to each other or a shape in which each of the plurality of concentric circles is at least partially separate.

The oil cover may be provided with a slant portion formed at an outer peripheral portion thereof in the sleeve direction. The oil cover may be a flat-type.

The depth of the groove may be in the range of 5 to 30% of the thickness of the oil cover.

According to another aspect of the present invention, there is provided a motor, including: a hydrodynamic bearing assembly according to various embodiments of the present invention, and a rotor rotating in association with the shaft.

According to another aspect of the present invention, there is provided a recording disk driving device, including: a motor rotating a recording disk according to the present invention; a head feeder feeding a head detecting information of the recording disk to the recording disk; and a housing receiving the motor and the head feeder.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view of a motor according to an exemplary embodiment of the present invention;

FIGS. 2A to 2E are plan views and cross-sectional views showing examples of an oil cover applied to an exemplary embodiment of the present invention shown in FIG. 1;

FIG. 3 is a schematic cross-sectional view of a motor according to another exemplary embodiment of the present invention;

FIG. 4 is a plan view and a cross-sectional view showing an example of an oil cover applied to another exemplary embodiment of the present invention shown in FIG. 3; and

FIG. 5 is a schematic cross-sectional view of a recording disk driving device equipped with a motor according to an exemplary embodiment of the present invention.

### DETAILED DESCRIPTION OF THE PREFERRED EMBODIMENT

Hereinafter, exemplary embodiments of the present invention will be described in detail with reference to the accompanying drawings. The exemplary embodiments of the present invention may be modified in many different forms and the scope of the invention should not be construed as being limited to the embodiments set forth herein. Rather, these embodiments are provided so that this disclosure will be thorough and complete, and will fully convey the concept of the invention to those skilled in the art. Therefore, it is to be noted that the shape and size of components shown in the drawings maybe exaggerated in order to provide a more clear description. Further, throughout the drawings, the same or similar reference numerals will be used to designate the same components or like components having the same functions in the scope of the similar idea.

### Hydrodynamic Bearing Assembly and Motor

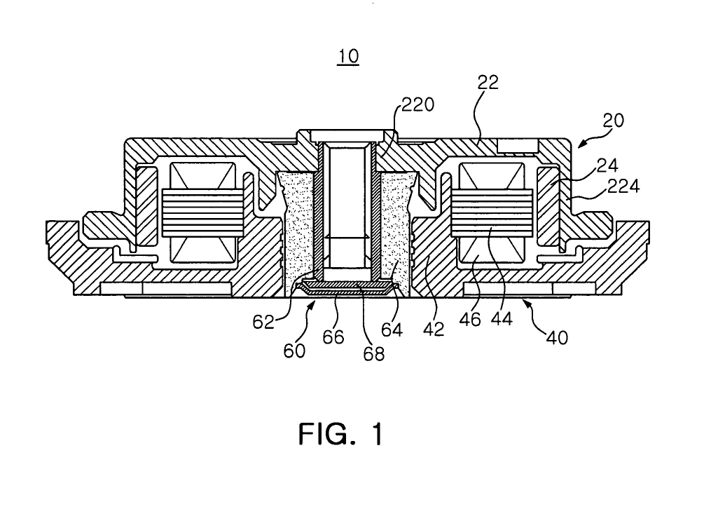

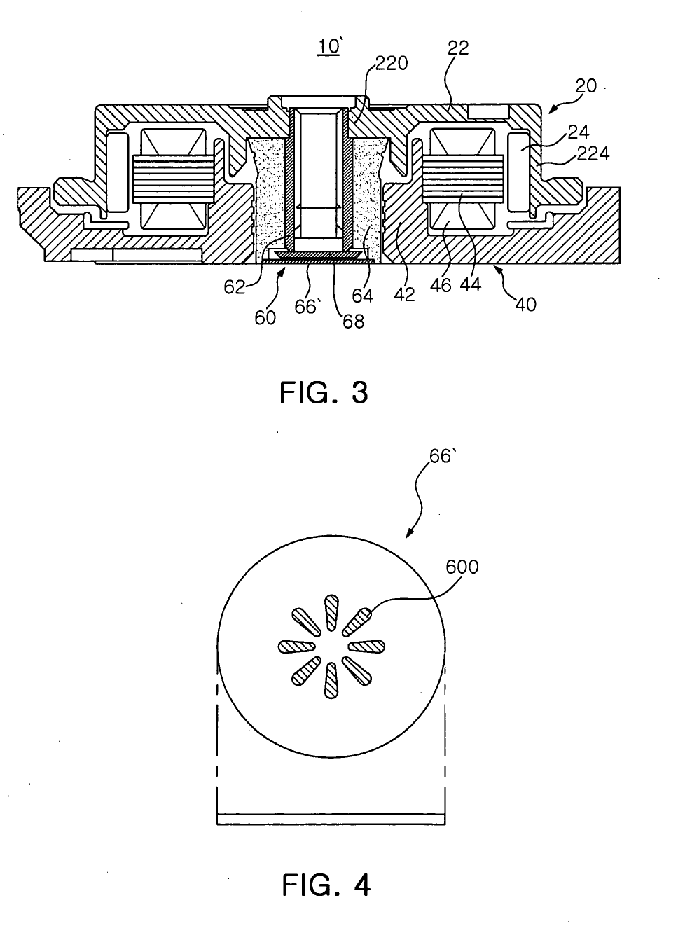

FIGS. 1 and 3 are schematic cross-sectional views according to several embodiments of the present invention.

Referring to FIGS. 1 and 3, motors 10 and 10′ according to several embodiments of the present invention may include a hydrodynamic bearing assembly 60, a stator 40, and a rotor 20.

The motor 10 according to the present embodiment, which is a motor for driving a recording disk such as a magnetic disk, for example, a hard disk or the like, and an optical disk, for example, a CD, a DVD, or the like, may largely include the stator 40 and the rotor 20.

The rotor 20 includes a cup-shaped rotor case 22 whose outer peripheral portion is provided with an annular magnet 24 corresponding to a coil 46 of the stator 40. The magnet 24 is a permanent magnet generating a magnetic force of a predetermined strength by alternately magnetizing an N pole and an S pole thereof in a circumferential direction.

In this case, the rotor case 22 includes a hub base 220 fixed while being press-fitted in an upper portion of a shaft 62 and a magnet support portion 224 supporting the magnet 24 of the rotor 20 by extending in an outer-diameter direction from the hub base 220 and being axially curved to the lower side thereof.

Meanwhile, terms relating to direction are defined. An axial direction means a vertical direction based on the shaft 62 when being viewed in FIG. 1, an outer-diameter or inner-diameter direction means an outer side edge direction of the rotor 20 away from the shaft 62, or an inner direction toward the shaft 62 based on the outer side edge of the rotor 20.

The stator 40, which means all fixing members except for rotating members, includes a support portion 42 fixing the hydrodynamic bearing assembly 60 of which outer peripheral surface is inserted thereinto, cores 44 fixed to the support portion 42, and a coil 46 surrounding the cores 44.

The rotor 20 is rotated by the electromagnetic interaction between the coil 46 and the magnet 24.

In addition, the hydrodynamic bearing assembly 60 may be fixed to an inner side of the support portion 42 of the stator 40 and include a sleeve 64 and oil covers 66 and 66′.

The sleeve 64 supports the shaft 62 so that upper portions of the shaft 62 are axially protruded upwardly.

In this configuration, the shaft 62 is inserted while having a micro clearance with a shaft hollow of the sleeve 64 and the micro clearance is filled with oil. A radial dynamic pressure portion (not shown) may be formed on at least one of the outer-diameter of the shaft 62 and the inner-diameter of the sleeve 64.

Although not shown, the radial dynamic pressure portion may include a herringbone-shaped grove and the herringbone-shaped groove generates radial dynamic pressure so as to smoothly support the rotation of the shaft.

A plate 68 having a thrust dynamic pressure portion (not shown) supplying thrust dynamic pressure may be provided at an end of the shaft 62.

The hydrodynamic bearing 60 or the motor 10 according to the embodiments shown in FIGS. 1 and 3 are different in view of the shape of the oil covers 66 and 66′. In the embodiments shown in FIGS. 1 and 3, the oil covers 66 and 66′ are fixed to the sleeve 62 in another side direction of one side of the shaft hollow into which the shaft 62 is inserted to block a leakage of oil remaining in the shaft hollow.

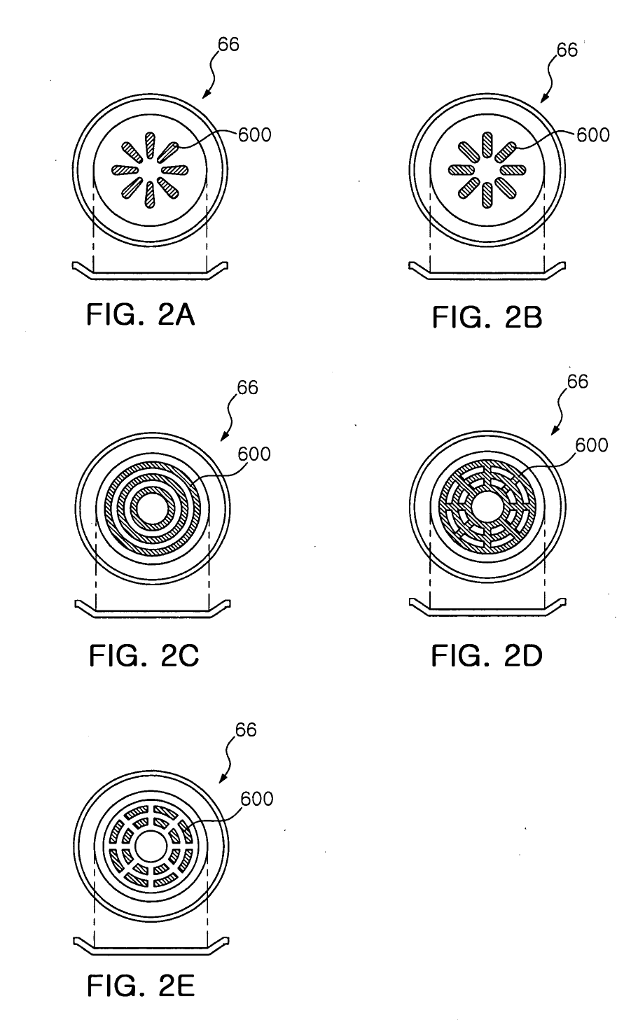

In the embodiment shown in FIG. 1, the oil cover 66 is provided with a slant portion formed at an outer peripheral portion thereof in the sleeve 64 direction. This will be described in more detail in FIG. 2.

Referring to FIGS. 2A to 2E, the oil cover 66 applied to the embodiment shown in FIG. 1 is provided with a slant portion formed at an outer peripheral portion thereof and ends of the slant portion are fixed and coupled to the sleeve 64, thereby having an advantage in view of securing rigidity.

Meanwhile, a groove 600 is formed on one surface of the oil cover 66, thereby making it possible to further improve the rigidity of the oil cover 66. As marked as ‘600’ and shown as a shaded area in FIGS. 2A to 2E, various shapes of grooves may be formed.

First, as shown in FIGS. 2A and 2B, a radial groove 600 may be formed, the radial groove 600 formed along a radius direction from the central portion of the oil cover 66. The radial groove may be formed to have a width increased in a direction towards an outer peripheral portion thereof as shown in FIG. 2A or have a constant width as shown in FIG. 2B.

Next, as shown in FIGS. 2C and 2E, the groove 600 may be formed on one surface of the oil cover 66, having a shape of a plurality of concentric circles. As shown in FIG. 2C, the groove may be formed to simply have a shape of a plurality of concentric circles, as shown in FIG. 2D, the groove may be formed to have a shape in which the plurality of concentric circles are partially connected to each other, and as shown in FIG. 2E, the groove may be formed to have a shape in which each of the concentric circles is partially separate.

In addition, in the embodiment as shown in FIG. 3, the oil cover 66′ is formed in a flat-type, without having a slant portion. The present invention forms the groove on the surface of the oil cover, thereby making it possible to secure the rigidity thereof. Therefore, the slant portion formed on the oil cover 66 in the embodiment as shown in FIG. 1 may be omitted. In the embodiment shown in FIG. 3, it is possible to secure the length of the hydrodynamic bearing much longer by omitting the slant portion.

FIG. 4 shows one example of the oil cover 66′ applied to the embodiment of FIG. 3. FIG. 4 shows the oil cover 66′ having a radial groove widening in a direction towards an outer peripheral surface; however, various shapes of grooves, as shown in FIGS. 2B to 2E, may be applied thereto.

In the embodiments shown in FIGS. 1 and 3, the depth of the groove may preferably be formed to be in the range of 5 to 30% of the thickness of the oil covers 66 and 66′, so as to secure appropriate rigidity of the oil covers 66 and 66′.

### Recording Disk Driving Device

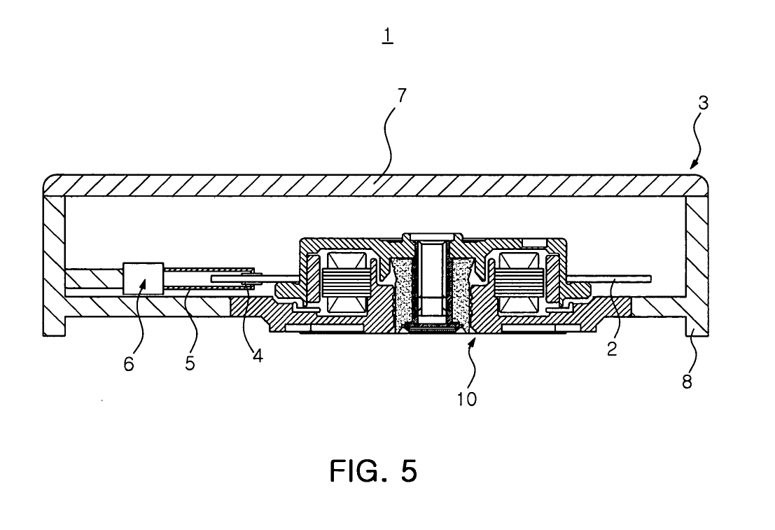

FIG. 5 is a schematic cross-sectional view of a recording disk driving device equipped with a motor according to an exemplary embodiment of the present invention.

Referring to FIG. 5, a recording disk driving device 1 according to the present invention, which is a hard disk driving device, includes a motor 10, a head feeder 6, and a housing 3.

The motor 10 has all of the characteristics of the motor of the present invention described above and is equipped with a recording disk 2.

The head feeder 6 feeds a head 4 detecting information of the recording disk 2 equipped on the motor 10 to the surface of the recording disk 2 to be detected. The head 4 is disposed on a support portion 5 of the head feeder 6.

The housing 3 may include a plate 8 equipped with a motor and a top cover 7 shielding an upper portion of the plate 8 equipped with a motor, so as to form an internal space receiving the motor 10 and the head feeder 6.

As set forth above, various shapes of grooves are formed on the oil cover, thereby making it possible to secure the rigidity of the oil cover.

In addition, according to the present invention, the oil cover can be formed to have a thinner thickness, while maintaining appropriate rigidity, to make the length of the bearing longer, thereby making it possible to improve the characteristics of the bearing.

In addition, according to the present invention, the oil cover can be manufactured as a flat-type, without forming a slant portion at an outer peripheral portion thereof, while maintaining appropriate rigidity, to make the length of the bearing longer, thereby making it possible to improve the characteristics of the bearing.

While the present invention has been shown and described in connection with the exemplary embodiments, it will be apparent to those skilled in the art that modifications and variations can be made without departing from the spirit and scope of the invention as defined by the appended claims.

What is claimed is:

1. A hydrodynamic bearing assembly, comprising:
a sleeve having a shaft hollow provided at one side thereof, the shat hollow being inserted with a shaft; and
an oil cover fixed to the sleeve in another direction of the shaft hollow and preventing a leakage of oil remaining in the shaft hollow,
wherein a groove for securing rigidity is formed on at least one surface of the oil cover.

2. The hydrodynamic bearing assembly of claim 1, wherein the groove for securing rigidity is radially formed on one surface of the oil cover.

3. The hydrodynamic bearing assembly of claim 2, wherein the groove for securing rigidity has a width widening in a direction towards an outer peripheral portion of the oil cover.

4. The hydrodynamic bearing assembly of claim 1, wherein the groove for securing rigidity has a shape of a plurality of concentric circles formed on one surface of the oil cover.

5. The hydrodynamic bearing assembly of claim 4, wherein the groove for securing rigidity has a shape in which the plurality of concentric circles are at least partially connected to each other.

6. The hydrodynamic bearing assembly of claim 4, wherein the groove for securing rigidity has a shape in which each of the plurality of concentric circles is at least partially separate.

7. The hydrodynamic bearing assembly of claim 1, wherein the oil cover is provided with a slant portion formed at an outer peripheral portion thereof in the sleeve direction.

8. The hydrodynamic bearing assembly of claim 1, wherein the oil cover is a flat-type.

9. The hydrodynamic bearing assembly of claim 1, wherein the depth of the groove is in the range of 5 to 30% of the thickness of the oil cover.

10. A motor, comprising:
a hydrodynamic bearing assembly of clam 1 and
a rotor rotating in association with the shaft.

11. A recording disk driving device, comprising:
a motor rotating a recording disk of claim 10;
a head feeder feeding a head detecting information of the recording disk to the recording disk; and
a housing receiving the motor and the head feeder.
